(19) United States
(12) Patent Application Publication
(10) Pub. No.: US 2019/0356941 A1
(43) Pub. Date: Nov. 21, 2019

(54) PORTABLE RADIO NETWORK ENABLED LED DISPLAY DEVICE AND SYSTEM

(71) Applicant: Custom Systems and Controls, Inc., Ashland, MA (US)

(72) Inventor: James Sullivan, Ashland, MA (US)

(73) Assignee: Custom Systems and Controls, Inc., Ashland, MA (US)

(21) Appl. No.: 16/414,473

(22) Filed: May 16, 2019

Related U.S. Application Data
(60) Provisional application No. 62/673,466, filed on May 18, 2018.

(51) Int. Cl. H04N 21/41; G06F 3/14

(52) U.S. Cl. CPC H04N 21/4126; G06F 3/1446; H04N 21/4122

(57) ABSTRACT

A system for communicating data among networked display signs comprises a plurality of display signs communicating with each other on a mesh network. Each display sign includes: a display screen for displaying visual messages; a radio controller for communicating on the mesh network; and a controller module coupled to the display screen and the radio controller, the controller module configured to receive data from one or more other display signs communicating on the network and, in response to the data, alter the visual messages displayed on the screen.

### CROSS REFERENCE TO RELATED APPLICATIONS

This patent claims priority to and benefit of U.S. Provisional Patent Application No. 62/673,466 (filed May 18, 2018), which is incorporated here by reference in its entirety.

### FIELD

The invention relates to portable displays and, more particularly, to a system for coordinating portable network-enabled portable displays.

### BACKGROUND

There are many known displays for presenting images. Many of these devices require existing power, networking, and separate image generating hardware. These devices are used to present static images in a predefined order, or images generated by a separate device.

### SUMMARY

There is a need for a portable network of displays to provide information for direction, entertainment, or other needs. The LED display network does not require any preexisting infrastructure and can expand to cover large areas of ground and interact with shorter range devices. Additionally, these displays may contain a processor capable of generating and displaying images based on input from other displays and devices in the network. Additionally, the network can be used for transmitting other data.

In an embodiment, a portable display unit comprises a display screen for displaying visual messages; a radio controller for communicating on a wireless network; and a controller module electrically coupled to the display screen and the radio controller, the controller module configured to receive data directly from one or more other display units or from a remote control unit communicating on the wireless network and, in response to the data, alter the visual messages displayed on the screen.

In another embodiment, a system for communicating data among networked display units comprises a plurality of display units communicating with each other on a mesh network. Each display unit comprises a display screen for displaying visual messages; a radio controller for communicating on the mesh network; and a controller module coupled to the display screen and the radio controller, the controller module configured to receive data from one or more other display units communicating on the network and, in response to the data, alter the visual messages displayed on the screen.

### BRIEF DESCRIPTION OF THE DRAWINGS

The objects and features of the invention can be better understood with reference to the drawings described below. The drawings are not necessarily to scale, emphasis instead generally being placed upon illustrating the principles of the invention. In the drawings, like numerals are used to indicate like elements.

FIG. 1 is a diagram of a display unit that includes both a head unit and a stand.

FIG. 2 is a diagram of a display screen with a grid of light emitting diodes (“LEDs”).

FIG. 3 is a diagram of a display screen with a grid of LEDs.

FIG. 4 is a diagram of a head unit with multiple display screens.

FIG. 5 is a perspective diagram of a head unit with multiple display screens.

FIG. 6A is a block diagram of a circuit for controlling a display screen.

FIG. 6B is a block diagram of a circuit for controlling an LED matrix.

FIG. 7A is a network diagram of a network of display units and other devices.

FIG. 7B is a network diagram of a network of display units and other devices.

FIG. 8 is a perspective view of a user holding a display unit.

FIG. 9 is a perspective view of a networked remote control that can communicate with display units.

FIG. 10 is a flowchart of a process for operating a display unit.

FIG. 11 is a flowchart of a process for executing the current state of a display unit.

FIG. 12 is a perspective view of a football field showing an example use of display units during a football game.

FIG. 13 is a top view of a parking lot showing an example use of display units for parking vehicles.

### DETAILED DESCRIPTION

A system may include multiple displays connected by a network. In embodiments, the displays may be LED-based displays. However, any type of display may be used. The network may be a mesh network. Each of the displays may include a communication module to communicate on the network to other displays and/or controllers. The displays may also include processors to control the display and handle communications on the network. In certain embodiments, one or more of the displays may include human-interface so that a user can enter data. The data may be used by the display that the user is using and/or may be communicated to other displays over the network.

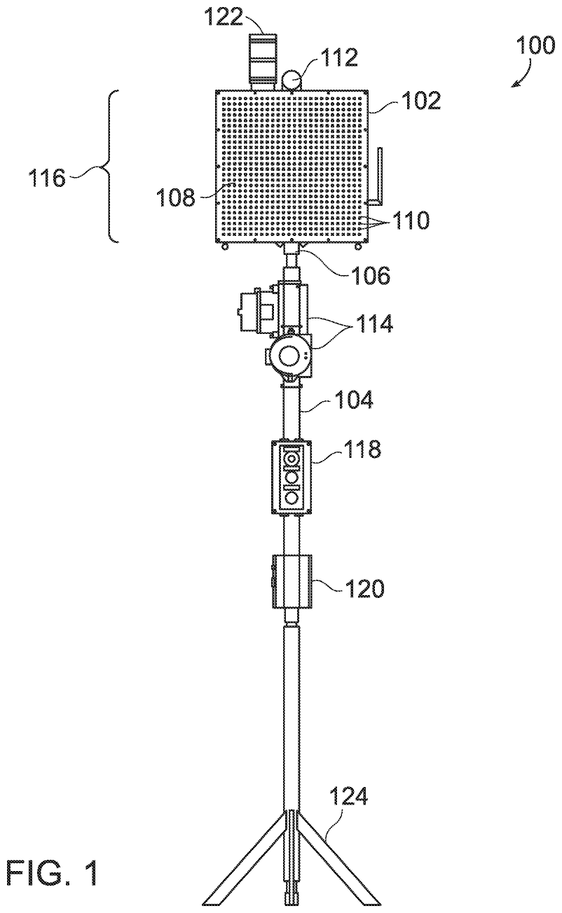

Referring to FIG. 1, a display unit 100 may include a portable display screen 102 coupled to a stand 104. Display screen 102 may include a fastener 106 to fasten display screen 102 to stand 104. Fastener 106 may be a detachable fastener configured to release and engage stand 104 quickly so that display screen 102 can be easily removed and/or fastened to another object such as a railing.

Display screen 102 may include panel 108, which may be capable of displaying symbols or messages. In an embodiment, panel 108 includes an array of light-emitting diodes (LEDs) 110 that can be illuminated or darkened in response to electrical signals to display the symbols or messages.

In certain embodiments, display screen 102 may also include a plurality of panels 108. Like panel 108, the additional panels may include arrays of LEDs that can be illuminated or darkened in response to electrical signals to display the symbols or messages. Embodiments with additional panels will be discussed below.

Display unit 100 may include a sound device 112 capable of creating audible sounds. In embodiments, sound device 112 may be physically connected to display screen 102. In some arrangements, sound device 112 may be detachably fastened to display screen 102 and may connect to an electromechanical port. Display unit 102 may include multiple electromechanical ports and may support multiple sound devices. Sound device 112 may comprise a speaker, a buzzer, a beeper, an audio amplifier, or any other device capable of receiving an electrical signal and, in response, producing an audible sound. In some arrangements, sound device 112 may be able to produce sound of sufficient volume or sound power so that it can be heard by players of a sporting event, spectators at a sporting event, drivers of cars in a parking lot, etc.

A visual indicator 122 may be coupled to display screen 102 to provide visual signals. These signals may include colored lights or other indicators that can be viewed from a distance.

Display unit 100 may also include one or more sensors 114. These sensors 114 may be physically coupled to stand 104, as shown, or may be physically coupled to the head unit 116 that comprises display screen 102. Sensors 114 may include global positioning system (“GPS”) sensors, light sensors, humidity sensors, weather sensors, proximity sensors, motion sensors, a magnetometer or compass, accelerometers, or any other type of sensor that can react to and generate a signal in response to changes in the environment around display unit 100. These sensors may allow display unit 100 to gather information about its location and position with respect to other display units so they can coordinate what is displayed based on their relative location and position.

One or more input user input devices 118 can be included. In embodiments, user input devices 118 may include buttons, switches, toggles, slides, or other mechanisms that can be activated easily by a user's fingers. User input devices 118 may also include more complex controls like a number pad, a keyboard, a microphone to accept voice commands, etc.

A power supply 120 may be electrically coupled to display screen 102. For example, wires or cables for carrying power may run through stand 104 from power supply to display screen 102. In other embodiments, for example when display screen 102 operates without being mounted on display screen 102, power supply 120 may be physically attached to display screen 102.

In embodiments, power supply 120 may comprise a battery that stores and provides electrical power to electronic and/or electro-mechanical elements of display unit 100. If the battery is rechargeable, power supply 120 may include a port that can receive electrical power to recharge the battery and, in some instances, a recharging circuit to recharge the battery. In some arrangements, power supply 120 may comprise a rectifier and voltage regulators, or other power supply circuits, that can convert standard AC power to DC power that can be used to run display screen 102.

Stand 104 of display unit 100 may include feet 124, a pedestal, or any type of temporary, permanent, or semi-permanent attachment that allows display unit 100 to stand on a surface. In other embodiments, stand 104 may be a monopod that can be held and moved by a user holding display unit 100.

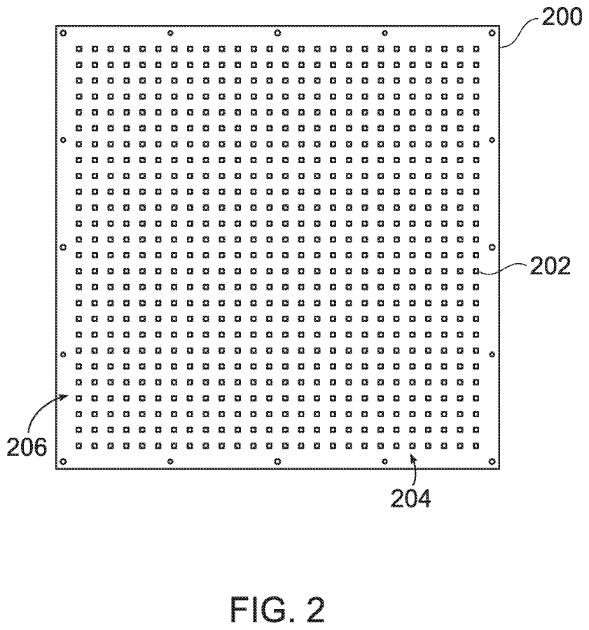

Referring to FIG. 2, display screen 200 may be the same as or similar to display screen 102. In embodiments, display screen 102 may comprise an array of light-emitting diodes (LEDs) 202. LEDs 202 may be arranged in a grid as shown, or in any other pattern. LEDs 202 may be high power or high-emission LEDs so that they can be seen during the daylight and/or over distances. For example, the LEDs individually or collectively may be seen by spectators across a field during a sporting event.

One configuration of LEDs may be a 26×26 matrix, but other sizes and configurations are possible. For a head unit with multiple display screens 200, the display screens can be chained. In embodiments, as many panels can be chained together to make a display of arbitrary size.

In some embodiments, display screen 200 may comprise a display screen of e-paper, OLED, LCD, LED in addition to or in place of the grid of LEDs 202.

LEDs 202 may comprise APA 106 style LEDs. These LEDs have a 4-wire connection (VCC, GND, Data In, Data Out). The VCC and GND connections may be electrically coupled to power supply 120 and the Data-In and Data-Out connections may be coupled to a circuit to control the brightness and color of the LED. Data-In and Data-Out may be coupled in parallel, in series, or each connected to individual IO ports of the control circuit.

LEDs 202 may be 3-color LEDs. The intensity of each color may be controlled by a pulse-width modulated (“PWM”) signal. In this case, the duty cycle of the PWM may control the intensity of the color

In another embodiment, LEDs 202 may be APA 102 LEDs. These LEDs have a six-wire connection (VCC, GND, Data In, Data Out, Clock In, Clock Out). The Clock-In and Clock-Out signals may be controlled by the control circuit. This may allow the display screen 102 to achieve a higher refresh rate. This has the advantage of being able to run faster, and also more reliably since time stability may be less of a concern than with the APA 106.

In embodiments, the LEDs may be surface mount for cheaper and/or more efficient placement. The entire display screen may comprise a single printed circuit board onto which the LEDs may be mounted to form the matrix of LEDs. In other embodiments, multiple PCBs may be used. The assembly, including the PCBs, may be then coated in a conformal coating which makes it water resistant. The support structure seals and the assembly (e.g. head unit 116) may also be water and weather resistant.

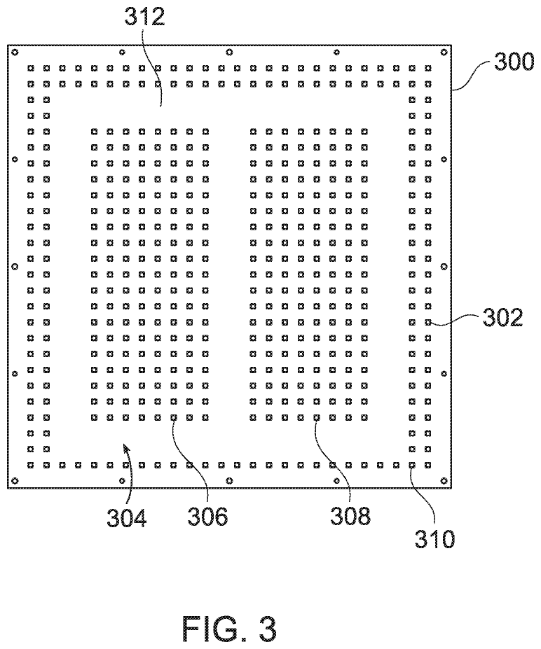

Referring to FIG. 3, display screen 300 may be the same as or similar to display screen 102 and/or display screen 200. LEDs 302 may also be the same as or similar to LEDs 202, as described above.

As shown in FIG. 3, the matrix 304 of LEDs 302 need not be a full, square matrix. In embodiments, matrix 304 may comprise one or more sub-matrices 306, 308, 310, and the like. Sub-matrices 306 and 308 are shown as rectangles and matrix 310 is shown as a border. However, the sub-matrices may be of any shape. In certain embodiments, the sub-matrices may be shaped as and/or depict pictures or images such as a symbol (an arrow, a line, a traffic signal, etc). To reduce the number of LEDs used, the space between the matrices of LEDs may by unpopulated.

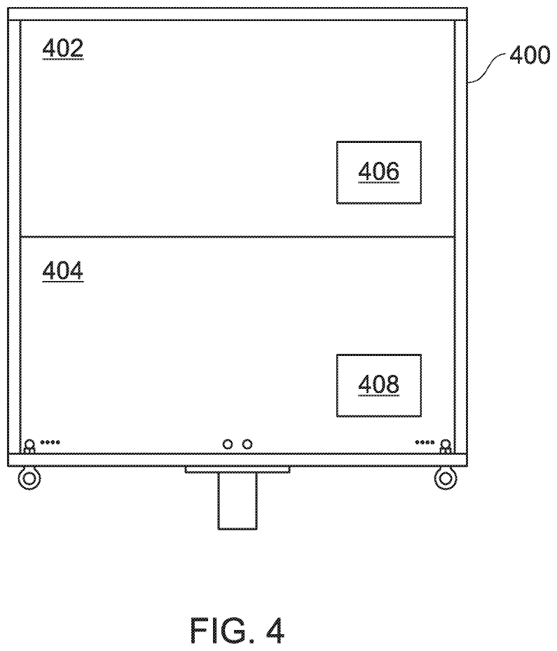

Referring to FIG. 4, head unit 400 may be the same as or similar to head unit 116. As shown, head unit 400 may include two display screens 402 and 404. Each of these display screens may be like display screen 102 and may include an array of LEDs. Also, each display screen 402 and 404 may be controlled by a separate, respective control circuit 406 and 408. In other embodiments, a single control circuit may control both display screens 402 and 404. Control circuits 406 and 408 may be processors, custom ASICs, or any type of circuit that can be used to receive signals or instructions and, in response, control the LEDs of the display screens. Control circuits will be discussed in greater detail below.

As shown, display screens 402 and 404 are substantially the same, rectangular size and arranged one on top of the other within head unit 400. However, this is not a requirement. The screens associated with a head unit may have any shape and be arranged in any physical configuration so they can be seen by observers looking at head unit 400.

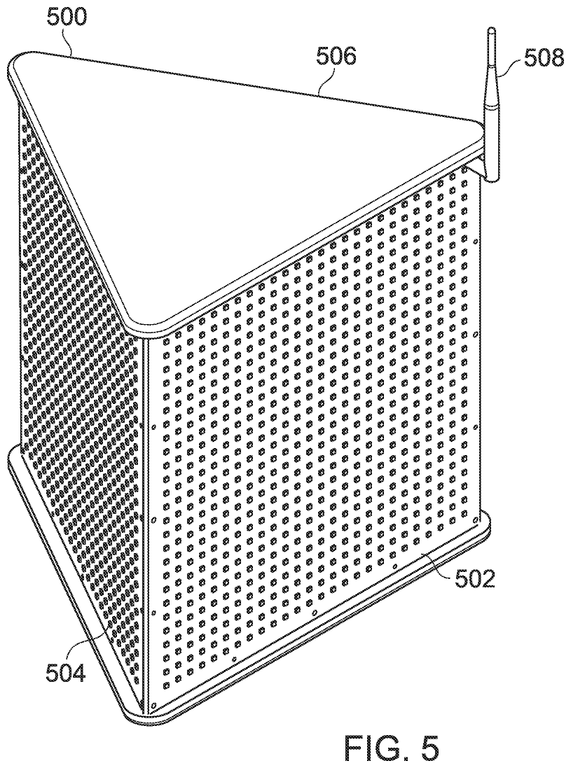

Referring to FIG. 5, head unit 500 may be the same as or similar to head unit 116. Head unit 500 may have a three-dimensional body with multiple sides. In this example, head unit 500 is shaped like a prism. However, other shapes may be used such as a cube, a three-dimensional rectangle, a pyramid, etc.

In embodiments, some or all sides of head unit 500 may include display screens. In the prism example, display screens 502, 504, and 506 cover the three rectangular sides of the prism. The top and/or bottom of the prism may also include display screens, though this is not shown in FIG. 5. In its interior, head unit 500 may house circuitry, battery packs, radios, and other circuitry that can control and/or operate alongside the display screens. For example, antenna 508, which extends outside of head unit 500, may be coupled to transceiver circuitry housed within head unit 500.

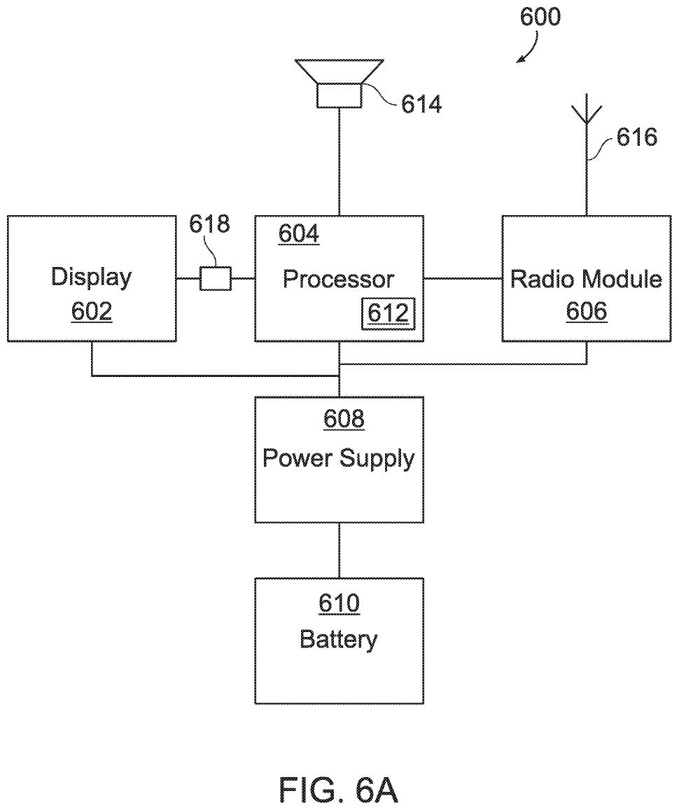

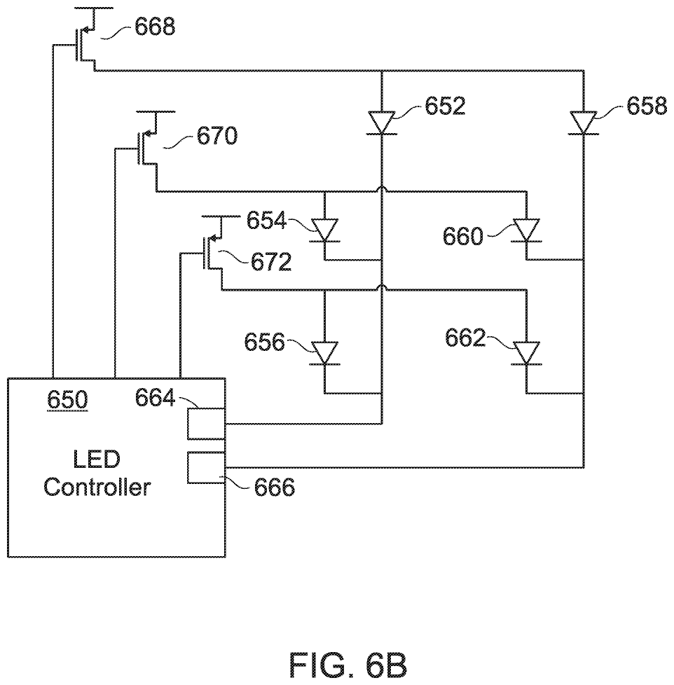

Referring to FIG. 6A, a circuit 600 for controlling display screen 602 includes processor 604 and radio module 606. A battery 610 and power supply circuit 608 may be included to supply power to processor 604, radio module 606, and display screen 602. Display screen 602 may be the same as or similar to display screen 102 (see FIG. 1).

Processor 604 may optionally include or be electrically coupled to a memory 612. Memory 612 may be a volatile or non-volatile memory and may include software instructions for processor 604 to execute in order to control display 602 and send and receive communications from radio module 606. In other embodiments, processor 604 may be a custom circuit that does not execute software instructions. In this case, processor 604 may be implemented as a state machine or other type of circuit.

Processor 604 may be a general-purpose processor or micro-processor that can execute an operating system such as Linux, Windows, Android, Arduino, or the like. Processor 604 may also include input/output interfaces such as IO pins, USB buses, wired network buses, SATA, SPI, SMBus, etc., to interact with a variety of hardware modules such as radio module 606, audio device 614, display screen 602, etc. In one embodiment, processor 604 is a 32-bit 180 MHz ARM Cortex-M4 processor having an SD card slot, USB interface, and running Teensy 3.6 software.

Radio module 606 may be a network-capable wireless radio module coupled to antenna 616. In embodiments, radio module 606 may implement any wireless network protocol including, but not limited to: ZigBee, DigiMesh 2.4, 802.15.4, 863-870 MHz, 900 MHz, LTE CAT1, LTE-M, NB-IoT, and Cellular 3G. Non-Digi modules may also be used, such as a Yadom™ module or a Roving Networks™ module. In embodiments, the radio module 606 may be mesh network adapter such as the Digi Xbee module.

The same API and control set can talk to many different types of modules. For example, a DigiMesh 2.4 API. With signs utilizing the S2C Pro Radios and an external antenna. Remotes may use an S2C with PCB Antenna. In embodiments, a software API may allow users of a PC to control or configure radio module 606 and or display screen 602.

These modules can be configured either via USB, through SPI, or over the Air. If there is no existing wireless network that radio module 606 can connect to, radio module 606 may create a new wireless network that other display signs can connect to and use to communicate. Initial network setup, as well as firmware upgrades, traffic monitoring, etc. may be handled using a configuration package, such as Digi's XCTU configuration package.

The radio module may be modular and may, for example, engage a socket on an interface board or PCB of the display sign, which may allow a user to easily configure the display sign to communicate on different types of networks.

As noted, radio module 606 may be configured to communicate on various types of mesh network architectures, topologies, protocols, and mesh network variations, such as ZigBee, Thread, IEEE 802.11, IEEE 802.15, FabFi, SMesh, switched mesh networks, half-duplex or full-duplex mesh networks, mesh networks without a control node, mesh networks with a control node, etc. Radio module 606 may also be configured to communicate on non-mesh networks such as routed networks, ring networks, peer-to-peer networks, and the like. Examples include Ethernet, Bluetooth, etc.

In embodiments, display unit 100 may include two or more radios. Each radio may be configured to communicate on the same network (or the same type of network), or on different networks (or types of networks). For example, if a sign has two radios configured to communicate on different networks, one may be configured to communicate on a ZigBee network and the other on an Ethernet network. Additionally, radio modules can be selected for compliance in different areas of the world.

In addition, radio module 606 may be able to connect circuit 600 to an existing wireless network and/or may be able to create a new wireless network if an existing wireless network cannot be found. By doing so, a plurality of display screens may form a network and may be able to communicate with each other and coordinate what is shown on the displays even if an existing wireless network is not available.

Processor 604 may communicate via SPI with radio module 606 and/or display screen 602. Radio module 606 and processor 604 may also communicate via a request line that carries a request signal. When the radio module 606 indicates, via the request signal, that radio communications need processing, the processor 606 may retrieve, parse, and interpret radio communications received by the radio module.

The processor 604 may execute software instructions which cause the networked display to operate. These instructions may, for example, include application specific state machines. One state machine may handle the configuration menu, another may handle normal operation of the display. The state machines may loop constantly updating the screen, polling the radios, and doing anything else required.

In an embodiment, circuit 600 may include a matrix driver circuit 618 to drive the LEDs of display screen 602. Examples of matrix driver circuits include the SBVS199B or TI TLC5958. Matrix driver circuit 618 may include an internal PWM circuit that can generate PWM signals to control the LEDs. This may improve LED color without the need to scan at such a fast rate. In embodiments, multiple matrix driver circuits may be used, for example, to control LEDs.

Referring also to FIG. 6B, processor 604 may control the LEDs of display screen 602 according to a so-called matrix fixed current controller PWM scheme. In this arrangement, an LED controller 650 may control one or more LED columns. LED controller 650 may be the same as or similar to matrix driver 618.

In this example, LED controller 650 is coupled a first column of LEDs consisting of LEDs 652, 654, and 656, and another column of LEDs consisting of LEDs 658, 660, and 662. A current driver (e.g current drivers 664 and 666) may be coupled to one end of each column of LEDs to drive current through the LEDs. In the example shown, current drivers 664 and 666 are part of LED controller 650. However, current drivers 664 and 666 may be separate from controller 650 and controlled by LED controller 650. For example, current drivers 664 and 666 may be provided by Texas Instruments® TLC59283 chips.

Also, at the end of each row is a power FET 668, 670, 672, which may act as switches.

LED controller 650 may control the LEDs by turning power FETs 668, 670, and 672 on and off to illuminate a single row of LEDs. LED controller 650 may then scan through all the rows repeatedly illuminating each one as appropriate to display the appropriate picture or symbol. The brightness of the LEDs may be controlled by driving turning current sources 664 and 666 on and off. For example, to illuminate only LED 652, LED controller 650 may turn FET 668 on, FETs 670 and 672 off, current driver 664 on, and current driver 666 off. In this manner, LED controller 650 may illuminate each LED in the matrix by scanning through each row and column to illuminate single LEDs or groups of LEDs. Also, LED controller 650 may control the brightness and color of the LEDs by using FETs 668, 670, and 672 to drive PWM signals to the LEDs and/or by controlling additional color inputs (not shown) to each LED.

Returning to FIG. 6A, processor circuit 604 and/or radio module 606 may be supported by an interface board. The interface board may also include additional support circuitry such as voltage regulators, shielding for regulatory compliance, over-current and over-voltage protection circuits, ROM or RAM memory, communication busses, etc.

In embodiments, the interface board also includes SPI or timing connections to the LED panels. Selectable level shifters may allow the signals going to the display screen to be either 5V, 3.3V, or a voltage reference provided by the panel. In addition to the standard SPI lines there are also reset, alarm, and attention lines.

Power supply 408 may be a DC-to-DC or AC-to-DC power supply that provides power to circuit 600 and display screen 602. It may include, for example, a buck/boost switching power supply to generate power for high-current devices in the system. This may include converting 14.8V nominal to 5V in the case where display screen 602 includes APA 102 or APA 106 LEDs, or 5V and 12V to provide power to matrix driver circuit 618. Additional features like power down, power good, battery level, and current monitoring may also be available.

Power source 610 may comprise a battery, an AC-to-DC power circuit, or any other type of circuit that can convert battery or wall power for display unit 100 to use. In the case of a battery, the battery may comprise ion cells, a fuse, power switch, a BMS (Battery management system), and a housing. The housing may wrap around stand 104 (see FIG. 1) to allow wires to run through the interior of stand 104 to head unit 116. In some embodiments, solar panels may be included that may charge the battery from sunlight. In other embodiments, a power supply that can be plugged into a power source (such as a wall outlet or other outlet) is included. Any type of power supply can be used to power the electrical and electronic elements of the sign.

In embodiments, the power source 610 utilizes 16 lithium ion cells in a 4S configuration resulting in a nominal 14.8V output. Over-current, over-voltage, under-voltage, and balance circuits may be included to control power output of the cells. Power source 610 may also be configured to send fault signals to processor 604. If processor 604 detects a fault, it may disconnect the batteries until the condition is corrected or reset. A fuse is provided for quick reaction to a short. An On/Off switch for full power control may be included.

In embodiments, the battery module 610 may provide about 180 Wh. The battery module may comprise a plurality of battery modules coupled together. This may be beneficial if, for example, the battery unit is to be shipped because some shipping services requires batteries to be under 100 Wh.

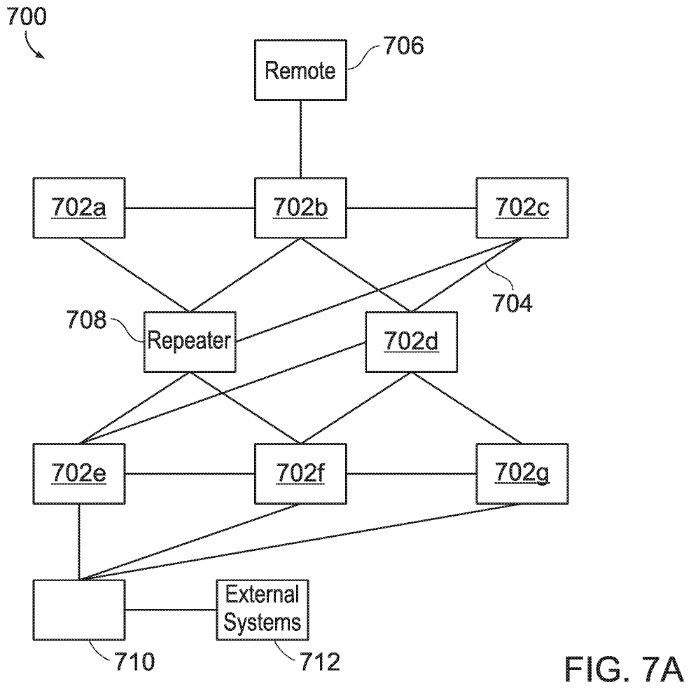

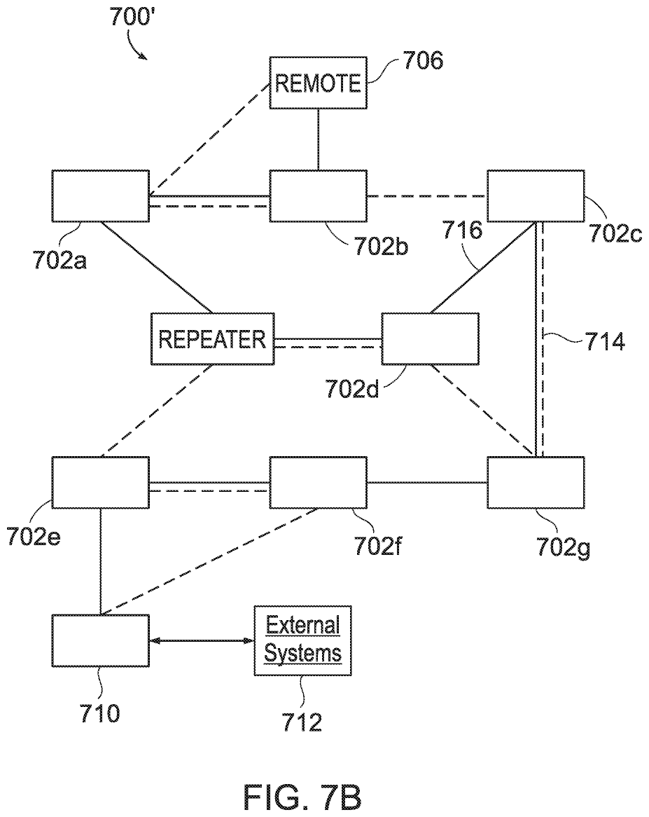

Referring to FIG. 7A, network 700 may allow for communication between networked devices including multiple display units 702a-g, one or more remote control units 706, a network extender or repeater 708, and a network bridge 710 or router. Bridge 710 may provide network connections between network 700 and external network devices 712 such as devices on the internet, devices on a mobile phone network, devices on another LAN, etc. Lines 704 between the devices denote wireless (or wired) network connections.

Network 700 may be a mesh network where display units 702a-g can dynamically connect or disconnect from other devices on the network. This may be useful if display units 702a-g are movable and may be repositioned while in use.

Referring to FIG. 7B, network 700′ is a hybrid mesh and routed network. Dotted lines 714 represent dynamic network connections that can be broken or reformed as the devices move from place to play. Solid lines 716 represent permanent (or semi-permanent) network connections that do not dynamically break and reform. The permanent network connections 716 may be useful if some or all of the display units are stationary. In this case, using permanent network connections can simplify routing network messages between display units and ensure that a path exists to communicate between any device connected via permanent network connections.

In embodiments, display units 702a-g may act as network endpoints for generating and receiving network data over network 700 and/or 700′. Additionally, or alternatively, display the network data is not addressed to a particular display unit, display units 702a-g may act as repeaters to pass information through network 700 and/or 700′.

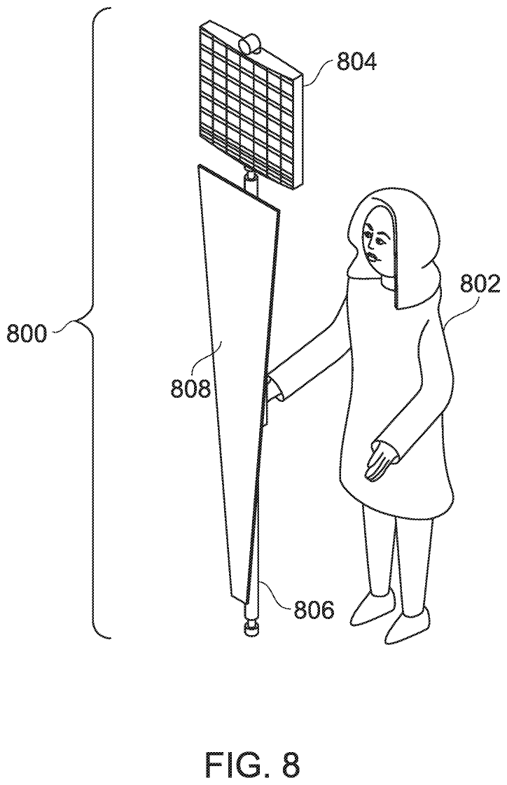

FIG. 8 is a diagram of a user 802 holding a display unit 800. Display unit 800 may be the same as or similar to display unit 100 (see FIG. 1). As shown, display unit 800 may include a head unit 804 and stand 806. In this instance, stand 806 is a monopod that can be held and moved by user 802. Optionally, display unit 800 may also include a banner 808 or other type of signage that can be viewed by spectators. As shown, display unit 800 may be a self-contained unit without any physical connectors or wires for power, network communications, or the like. The lack of any tethers or physical connection allows user 802 to carry and move display unit 800 freely and without limitation.

In some embodiments, head unit 804 may be disconnected from stand 806 and placed at a particular location. For example, if multiple display units 800 are to be used at a football game, some of the display units may be used as down markers and may be carried and moved by a user. Other display units (or head units) may be clipped and positioned in place around the football field to provide information, such as score, time on the play clock, and the like to onlookers.

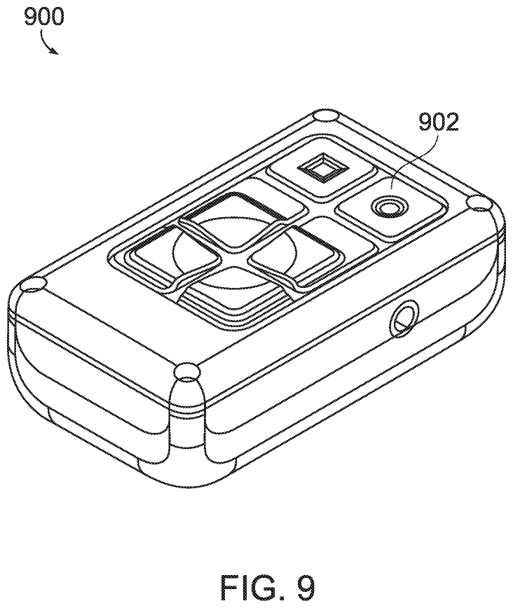

Referring to FIG. 9, a networked remote control 900 may communicate on the same network (e.g. network 700 or 700′) as one or more display units. Remote control 900 may include a processor (e.g. processor 604) a radio module (e.g. radio module 606) and a power supply and/or power source (e.g. power supply 608 and/or power source 610). Remote control 900 may also include one or more user inputs 902, which may be buttons, sliders, toggles, keyboard keys, or any other type of user input that can be activated by a user's fingers. When a user input 902 is activated, remote control 900 may communicate over the network to the display units which may react to the event. Using the football game example, a referee may carry remote control 900. When a play ends, the referee may activate user inputs 902 to indicate the current down. Remote 900 may then communicate the user input activation to the display signs. In response, the display signs communicating on the network may then change the information on their display screens to reflect the current down.

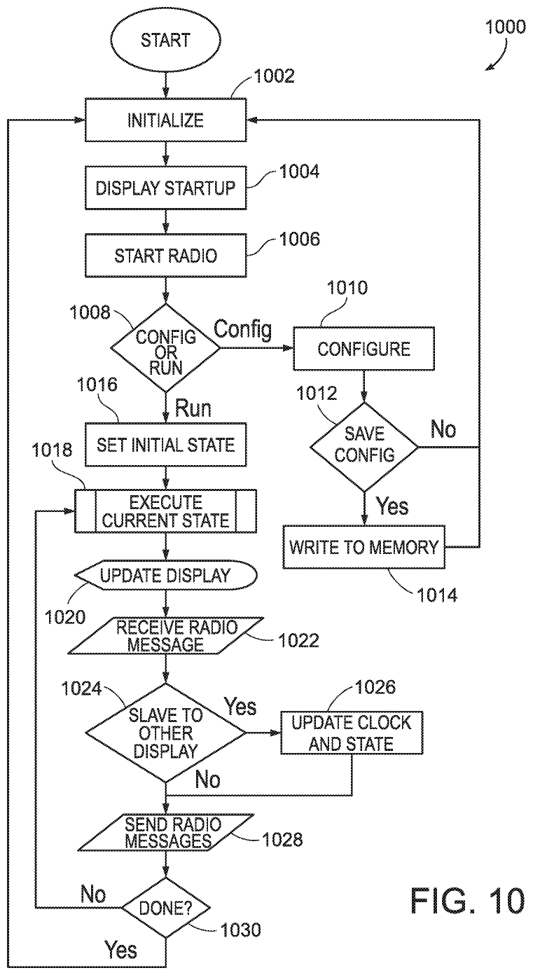

FIG. 10 is a process 1000 for startup and operation of a display screen. Referring also to FIG. 6A, in box 1002 processor 604 may power up and initialize. In box 1004 display screen 602 may receive power and in box 1006 radio module 606 may receive power.

In box 1008, processor 604 may determine if it is in configuration mode or run mode. In configuration mode, processor 604 will proceed to box 1010 where a user may be presented with a selection menu or prompts allowing the user to select options to control the display unit operation. For example, a user may configure the display unit to be a network master or slave; to play sound or no sound; to have a particular display brightness or brightness range; set a network ID; etc.

Once the display unit is configured, processor 604 may determine if the configuration needs to be saved in box 1012 and may save the configuration in box 1014.

If, in box 1008, processor 604 determines that it is in run mode, it will proceed to box 1016 where it will set the initial state for the LEDs of the display unit. The initial state may be a display or pattern that is stored in memory. When setting the initial state, processor 604 may set the LEDs to match the pattern.

In box 1018 processor 604 may execute the current state by preparing data needed to present the image. This may include incrementing timers, determining data to be transmitted, generating an image to be displayed, determining if it is time to move to the next state, etc. In box 1020 the current state may be updated and presented on display 602.

In box 1022, processor 604 may communicate with radio module 606 to determine if any messages have been received from other networked devices and to receive and process them. In box 1024, processor 604 may determine if it is a network master or a network slave to another device. If it is a network slave, process 604 will proceed to box 1026 to sync its communication clock with the other device. In box 1028, processor 604 may send any messages onto the network from its outgoing message queue.

In box 1030, processor 604 may determine whether the process should complete. If so, processor 604 may return to box 1002. If not, processor 604 to continue to box 1018 to update the display and send messages (e.g. boxes 1020-1028).

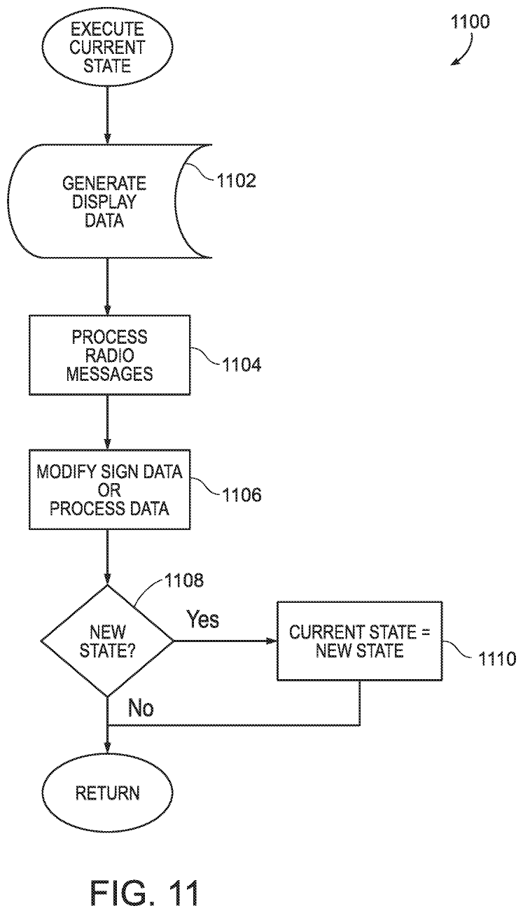

Referring to FIG. 11, process 1100, which may be executed by processor 604, may execute the current state of display unit 100. In embodiments, process 1100 may be a sub-process or breakout of box 1018 (labeled “Execute Current State”) in FIG. 10.

In box 1102, processor 602 may generate display data. In one example, generating display data may comprise setting output signals to proper levels in order to control the color and brightness of LEDs on the display screen. In embodiments, generating display data may comprise filling one or more memory display buffers with data that can be displayed by the display screen.

In box 1104, processor 604 may process radio messages. In other words, it may process and parse network messages that it receives from network devices. In box 1106, processor 604 may modify its sign data (e.g. modify that image that is displayed on the display screen) or process any non-display data that it receives from the network.

In box 1108, processor 604 may determine if a new display state was created, i.e. if the image that is to be displayed was changed by any of the network messages or by any user input. If so, processor 604 may set the current state to the new state in box 1110 so that the new state is displayed on the display screen.

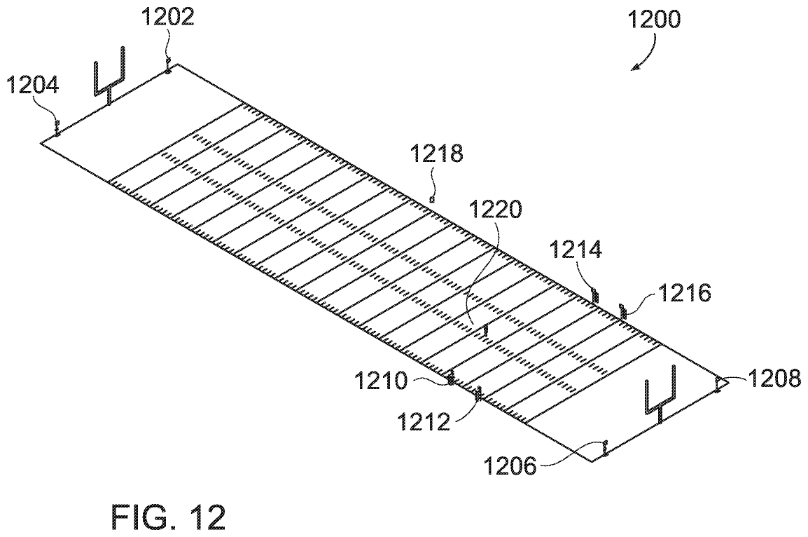

Referring to FIG. 12, various display units are shown in use on a football field 1200. Display units 1202, 1204, 1206, and 1208 are positioned in the endzones and may display data such as the current score, the play clock, the game clock, etc. These display units may be attached to stands or may be head units that are detached from stands and attached to a fence or other structure in or near the endzone. In embodiments, these display units may include multiple display screens so they can be seen from the front or back.

Additionally, or alternatively, display units 1210, 1212, 1214, and 1216 may be used as first down and line of scrimmage markers. These display units may include stands or monopods so that they can be carried and moved by a user as the line of scrimmage and first down lines change. In embodiments, these display units may display the current down, the number of yards until first down, the play clock, the game clock, or any other information related to the game. Also, one or more of these display units may sound a buzzer, bell, or other audible sound at various times to let the players and/or spectators know when a game event has occurred. For example, in certain flag football leagues, defensive rushers are not allowed to blitz past the line of scrimmage until a few seconds after the snap. One of the display units may be configured to generate an audible alarm at that time to let the players know when they can rush across the line of scrimmage.

One or more referees 1220 may hold a networked remote (e.g. remote 900 in FIG. 9). At certain time during the game, the referee may press buttons on the remote in response to game events. For example, if there is a flag on the play, the referee can press a flag button on the remote. In response, one or more of the display units around the field may change its display to indicate there was a flag on the play.

The display units and remotes (and optionally any repeaters, which are not shown in FIG. 12) may form a network as described above. They can communicate with each other over the network to coordinate and synchronize game data that is displayed on the display units. Also, one or more network gateways 1218 may be positioned near the display units so that the display units can communicate to other, external networks. This may allow the display units to send game data to web pages, to television crews, or other recipients using other networks so that the game data can be enjoyed by more remote viewers. This may also allow the display units to send data, through the gateway, to a scoreboard which can receive the data and display it on a large screen. Also, the display units to communicate and coordinate data with other networks of display units. For example, a display unit may send information about the score of the game to a nearby field where another game is being played. The score may then be displayed by the display units or scoreboard of the other field for any spectators who are interested.

Some examples of how the display units may be used follow.

A referee may control the signs to that they display information pertinent to the game. There is a 25 second play clock that runs from the time the ball is set to the time the ball is hiked. If this clock runs out the team loses a down. One of the display units may display the 25 second play clock.

Once the ball is snapped, the defending team must wait 2 seconds before rushing. One or more of the display units can sound an audible alert once the two second time has passed. If the defenders do not rush, the quarterback (“QB”) must throw the ball in the next 2 seconds. One or more of the display units can sound a second audible alarm to indicate the time to throw the ball as passed.

To facilitate a game of flag football, the sign may display various indicators such as: Endplay—displayed when a play has ended, Down Display—displays the current down and direction (the direction may be shown by an arrow, for example), Play clock—displayed once the ball has been set until it is hiked, Wait—Displayed when the defending players cannot rush, Go—Displayed when the defending players can rush, and Go Play—Displayed when the QB is scrambling or has passed. Other game events may also be displayed.

The referee's remote may include the following buttons, functions, or other features that the referee can use to indicate: Start/Stop—Starts and stops the play clock or stops the play, Hike/Pass/Rush—Notifies the sign that one of these events has happened, Change Down—Allows the ref to change a down, Change Direction—Allows the ref to notify the sign of a change in the direction of play, Configuration—Notifies a sign that the ref would like to address the configuration.

Signs may also be configured for broadcast mode (i.e. where one sign broadcasts data to the other signs) or Listen/Send mode (where the referee's remote is configured to communicate with a single sign). If other signs are present, the sign that receives data from the referee may rebroadcast the data to the other signs.

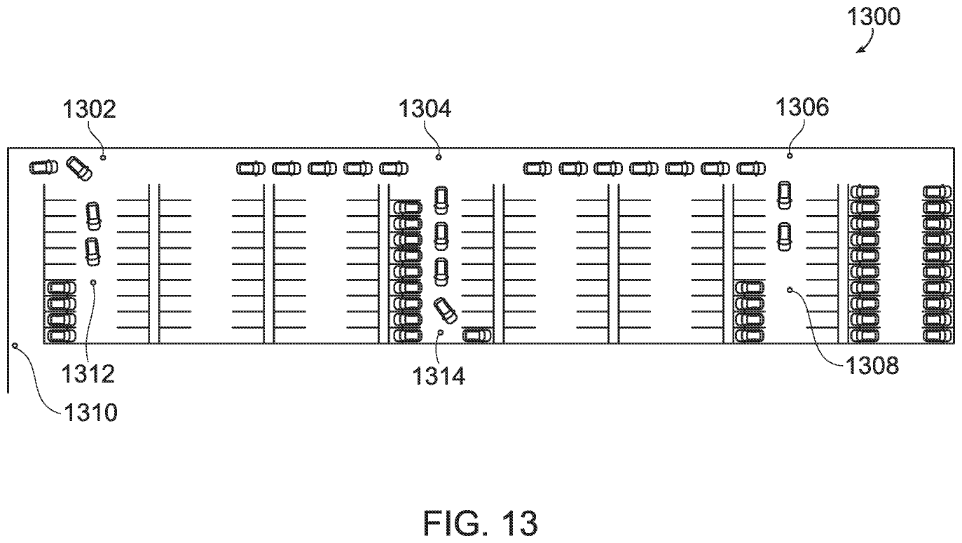

Referring to FIG. 13, as another example, display units may be used to assist with directing cars in a parking lot 1300. Efficiently filling parking lots is difficult to coordinate and time consuming. For this example, assume a parking lot has one lane down one side and 18 rows requiring a right turn. The cars come down the single lane and are parked next to each other by an attendant. Typically, this requires a string of people each directing a string of cars in and filling the parking lot from the back to the front.

Display units may be used to replace the attendants. The signs may be configured to display information such as: Stop, Straight Ahead Arrow, Right Arrow, Left Arrow, Back up Arrow or indicator, Numbers 1-9, or the like.

In embodiments, the display units 1302, 1304, 1306, and 1308, used for parking may include two input buttons: backed up—a button that the operator presses when cars back up and jam at his location, and OK—to provide acknowledgement. A user may press these buttons to indicate that a backup has occurred or to acknowledge the backup.

Additionally, or alternatively, an attendant may have a remote (e.g. remote 1312 or 1314) that includes the following functions: Start, Stop, Full, Request Car. These functions can be used to control the flow of vehicles through the parking lot 1300.

In one implementation, display units are arranged in various rows of cars to direct the flow of traffic. Attendants may have remotes configured to talk to the display units the row. Each sign is configured to talk to the sign before it (in the direction of traffic).

As an example, the display unit starts in stop mode. If a display unit receives a start command the display unit displays a right arrow, providing it is not displaying a straight-ahead arrow. It also sends a “request for cars” to the display unit before it. If a display unit receives a “request for cars” it displays a straight-ahead arrow and sends a “request for cars” to the display unit before it. If a display unit receives a “stop” command. The display unit displays stop. It also sends a “no more cars” to the display unit before it. If a display unit receives “no more cars” and has received a start command the display unit displays a right arrow and sends a request for cars to the display unit before it.

If an operator presses the “backed up button” the display unit sends a “no more cars” to the display unit before it. If the display unit receives a “Request Car” from remote, the display unit increments a counter, beeps and displays the number. It sends the number up to the display unit before it. If an operator presses the “OK” button the display unit decrements its counter and chirps, when the counter hits 0 it resumes what it was previously doing.

When the parking lot is empty the farthest away operator requests a Start. Their display unit will display an arrow. Subsequently, a chain reaction of “request for cars” messages from display unit to display unit will cause all other display units to display green arrows. Traffic may then begin flowing into the parking lot.

If traffic backs up to the farthest (last) display unit, an operator with a remote may press a “backed up” button. One or more of the display units may then send a “no more cars” to the display unit before it. By reacting to attendant input and traffic flow, the display units may be used to control the flow of traffic into the parking lot.

Display units may be used for various other applications. A networked system of display units can cover large areas and coordinate dynamic detouring. Sensors attached to the display units can indicate backups which would not be visible to operators at the active site. This data could be presented on a display unit for an operator, or the display units themselves could do the traffic direction. For example, detouring a main road using two routes with dynamic display units to minimize delays.

Another example application is traffic light replacement. Multiple display units can be coordinated to provide direction through intersections and coordinated with adjacent roads or intersections.

A number of implementations have been described. Nevertheless, it will be understood that various modifications may be made. Accordingly, other implementations are within the scope of the following claims. The steps and boxes of any flowcharts or processes described above may be rearranged in any appropriate order for their purpose. Some or all the flowcharts and processes described above may be implemented as instructions (e.g. software or firmware) that can be executed by a processor. Execution of the instructions by the processor may cause the processor to perform the steps that effectuate the flowchart or described process.

All patent applications, patents, or other references cited above are incorporated here by reference in their entirety.

1. A portable display unit comprising:
a display screen for displaying visual messages;
a radio controller for communicating on a wireless network; and
a controller module electrically coupled to the display screen and the radio controller, the controller module configured to receive data directly from one or more other display units or from a remote control unit communicating on the wireless network and, in response to the data, alter the visual messages displayed on the screen.

2. The display unit of claim 1 wherein the controller module is further configured to send data to the one or more other display units communicating on the mesh network to cause the one or more other display units communicating on the mesh network to alter visual messages displayed on respective screens of the one or more other display units.

3. The display unit of claim 1 further comprising an enclosure and a battery power source.

4. The display unit of claim 3 wherein the display unit is capable of being held and carried by a human.

5. The display unit of claim 4 wherein the display unit is a marker for a sporting event or a sign to provide direction to a viewer of the display unit.

6. The display unit of claim 1 wherein the controller module is further configured to receive from and/or send data to a gateway communicating on the mesh network.

7. The display unit of claim 1 wherein the wireless network is a full mesh network or a partial mesh network.

8. The display unit of claim 1 further comprising one or more additional display screens.

9. The display unit of claim 8 wherein the controller module is configured to control the display of the additional display screens.

10. The display unit of claim 8 further comprising one or more additional controller modules electrically coupled to control a respective one of the additional display screens.

11. The display unit of claim 1 wherein the radio controller acts as a network master to control at least one other display unit communicating on the wireless network.

12. The display unit of claim 1 wherein the controller module is configured to detect if the wireless network has been established and, if the wireless network has not been established, to establish the wireless network.

13. The display unit of claim 1 wherein the display screen comprises an array of light-emitting diodes (LED).

14. The display unit of claim 13 wherein the LEDs are high power LEDs with sufficient brightness to allow the display screen to be seen from a distance of 50 ft or greater in an outdoor daytime environment.

15. The display unit of claim 13 wherein the array of LEDs comprises a pattern specific to display a symbol or set of symbols.

16. The display unit of claim 1 wherein the control module is configured to generate a network message to be transmitted to the one or more other display units communicating on the wireless network.

17. The display unit of claim 16 wherein the network message comprises instructions for

[symbol]

18. A system for communicating data among networked display units comprising:
a plurality of display units communicating with each other on a mesh network, each display unit comprising:
a display screen for displaying visual messages;
a radio controller for communicating on the mesh network; and
a controller module coupled to the display screen and the radio controller, the controller module configured to receive data from one or more other display units communicating on the network and, in response to the data, alter the visual messages displayed on the screen.

19. The system of claim 18 further comprising a remote control communicating on the mesh network, wherein the remote control is configured to communicate data to at least one display unit of the plurality of display unit; and
the at least one display unit is configured to transmit messages to other display units of the plurality of display units in response to receiving the data from the remote control.

20. The system of claim 18 wherein the controller module is further configured to send data to the one or more other display units communicating on the mesh network to cause the one or more other units communicating on the mesh network to alter visual messages displayed on respective screens of the one or more other display units.

21. The system of claim 18 wherein at least one of the plurality of display units comprises an enclosure and a battery power source, wherein the display unit is portable.

22. The system of claim 21 wherein at least one of the plurality of display units is capable of being held and carried by a human.

23. The system of claim 18 wherein at least one of the plurality of display units is a sideline marker for a sporting event.

24. The system of claim 18 wherein at least one of the plurality of display units is a sideline marker for a football game.

25. The system of claim 18 wherein the mesh network is a full mesh network or a partial mesh network.
